(19) United States
(12) Patent Application Publication
(10) Pub. No.: US 2018/0025461 A1
(43) Pub. Date: Jan. 25, 2018

(54) DYNAMIC INTERACTIVE NAVIGATION

(71) Applicant: NCR Corporation, Duluth, GA (US)

(72) Inventors: Venkata Ramesh Kumar Kadali, ANDHRA PRADESH (IN); Venkatarayudu Chinthala, HYDERABAD TELANGANA (IN); Mallesh Kolanu, HYDERABAD TELANGANA (IN); Dixith Rama, HYDERABAD TELANGANA (IN)

(21) Appl. No.: 15/218,641

(22) Filed: Jul. 25, 2016

(51) Int. Cl. G06Q 90/00; G01C 21/20

(52) U.S. Cl. CPC G06Q 90/20; G01C 21/206

(57) ABSTRACT

A consumer-operated device dynamically and interactively communicates with a digital sign of a venue. Navigation/route data to specific points of interest within the venue, as identified by the consumer, are provided on the consumer-operated device for dynamically routing the consumer-operated device to the points of interest within the venue.

### BACKGROUND

Many consumers have navigation systems as standalone devices that they operate or nowadays on their phones. These products are a good means for navigation when getting from a starting location to an ending location, but are not designed and do not assist with navigation within a particular venue (such as a mall or amusement park).

In response, the industry has developed standalone kiosks at venues that a consumer can access to receive map information and routing information within the venue.

However, these kiosks: can have long consumer queues waiting to access the kiosks, require maintenance (which means downtime such that the consumer cannot access the kiosks), are expensive to deploy (at a large venue with heavy consumer traffic a significant number of these kiosks would need to be deployed to be of any real value to the consumer), require a consumer to remember the directions or manually write the directions down, and require a consumer to first locate the kiosk for initial access.

### SUMMARY

In various embodiments, methods and a digital sign for dynamic and interactive navigation are provided.

According to an embodiment, a method for dynamic and interactive navigation is provided. Specifically, a selection is received from a device for a location within a venue. Next, navigation data is provided to the device for routing the device from a device location to the location within the venue.

### BRIEF DESCRIPTION OF THE DRAWINGS

FIG. 1A is a diagram illustrating components of a dynamic interactive navigation system, according to an example embodiment.

FIG. 1B is a diagram of a digital sign employing dynamic interactive navigation, according to an example embodiment.

FIG. 2 is a diagram of a method for dynamic interactive navigation, according to an example embodiment.

FIG. 3 is a diagram of another method for dynamic interactive navigation, according to an example embodiment.

FIG. 4 is a diagram of a digital sign, according to an example embodiment.

### DETAILED DESCRIPTION

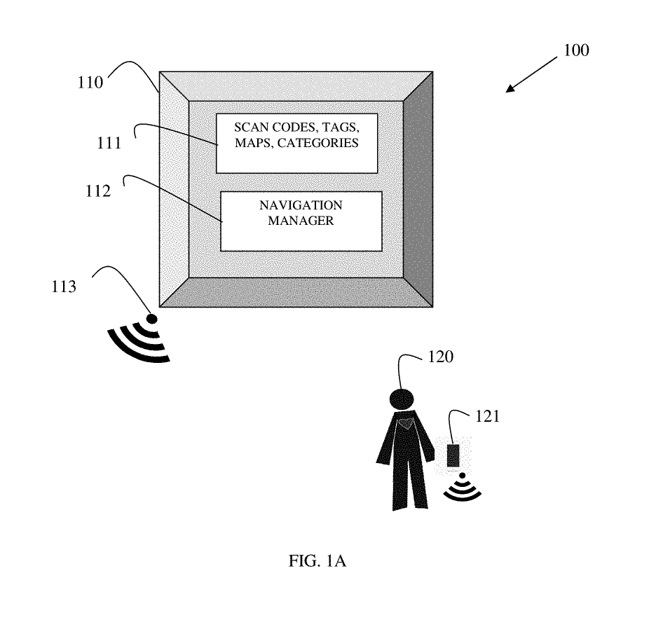

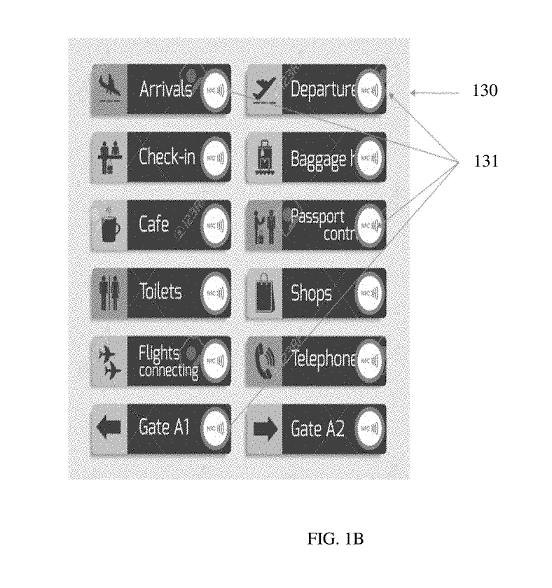

FIG. 1A is a diagram illustrating components of a dynamic interactive navigation system 100, according to an example embodiment. It is to be noted that the dynamic interactive navigation system 100 is shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of dynamic interactive navigation techniques, presented herein and below.

Furthermore, the methods and the digital sign presented herein and below (for dynamic interactive navigation) may include all or some combination of the components shown with the system 100. The methods are programmed as executable instructions in memory and/or non-transitory computer-readable storage media and executed on one or more processors associated with the components/devices.

Specifically, the system 100 includes a digital sign 110 and a consumer operated device 121. The digital sign 110 includes: 1) scan codes, maps, and/or venue-related categories 111; 2) a navigation manager 112, and, optionally, 3) a wireless beacon transceiver 113. The consumer-operated device 121 is operated by a consumer 120.

The digital sign 110 includes one or more processors, memory, non-transitory computer-readable storage media, and one or more network ports (for wireless and/or wired network communication).

The digital sign 110 also includes a variety of dynamic and interactive interface mechanisms 111, such as, but not limited to: scan codes, interactive maps, and venue-related categories 111. The interface mechanisms 111 include at least two primary components: a presentation mechanism for displaying information on the display of the digital sign for viewing and interaction by the consumer 120 and a software Application Programming Interface (API) to communicate, when necessary, consumer device selections to the navigation manager 112.

The digital sign 110 is either preconfigured and/or dynamically and periodically determines its geographic position and position within cartographic data for a particular venue for the geographic position. In an embodiment, the cartographic data for the venue resides in storage within the digital sign 110 and is periodically updated over a network connection with a server or with an administrative device in wired or wireless communication with the digital sign 110. The navigation manager 112 has access to the position data (geographic position and position within the cartographic data for the particular venue) and the cartographic data (when resident and accessible within storage of the digital sign 110.

In an embodiment, the interface mechanism 111 is a displayed map of a venue (airport, train station, bus station, boat port, sports or Entertainment Park, amusement park, hospital, government facility, park, college or university, and others). In an embodiment, the map includes displayed depictions of specific points of interest within the venue along with a scan code (such as a Quick Response (QR) code or barcode) for each point of interest that can be scanned by the consumer 120 operating a camera of the consumer-operated device 121 (phone, tablet, wearable processing device, etc.). In an embodiment, the displayed map is generated and rendered by the navigation manager 112 from cartographic data resident in storage within the digital sign 110 for the venue.

In an embodiment, the interface mechanism 111 is displayed as a map of the venue (as discussed in the previous embodiment) with displayed depictions next to each point of interest within the venue for tapping the consumer-operated device 121 on specific points of interest desired by the consumer 120 using Near-Field Communication (NFC) between the interface mechanism 111 and the consumer-operated device 121.

In an embodiment, the interface mechanism 111 is a displayed listing of categories having one or more points of interest within the venue. Each category accessible by scanning a code presented next to the displayed category or by tapping the consumer-operated device 121 in a displayed location next to the displayed category using NFC (an example illustration of this embodiment is provided below in the FIG. 1B).

Processing of the embodiments of the system 100 can proceed in a variety of manners, some of which are now presented as illustrative examples.

One or more digital signs 110 are located at positions throughout a venue, such as positions where consumers enter the venue and/or positions where consumers are likely to inquire for directions to other positions within the venue.

In an embodiment, the consumer-operated device 121 includes a customized mobile application (app) that executes on the consumer-operated device 121 and connects and interacts with the digital sign 110 through the navigation manager 112 and/or the interface mechanism 111. In an embodiment, the digital sign 110 or other non-digital signage at the venue includes a QR code that when scanned by the consumer-operated device 121 automatically downloads, installs, and executes the mobile app on the consumer-operated device 121 by redirecting a browser application to a web site having the software to automatically download, and, optionally, register the consumer 120 and the consumer-operated device 121 (the downloaded app is configured on download to install and automatically execute on the consumer-operated device 121). In an embodiment, the consumer is provided information either displayed on the digital sign 110 or non-digital signage as to an app name or a website that the consumer can use in connection with other applications that typically execute on the consumer-operated device 121 (such as app store applications and/or web browsers) to download, install, and execute the mobile app.

In an embodiment, when the consumer-operated device 121 approaches the digital sign 110 within a preconfigured distance, the mobile app detects a wireless signal transmitted from the wireless beacon transceiver 113 of the digital sign 110 and displays a notification within a consumer-facing interface of the mobile app on the consumer-operated device 121. The interface present within a display of the consumer-operated device 121 a same, similar, or different depiction of what is presented on the display of the digital sign 110 for the interface mechanism 111. This embodiment permits a consumer to acquire and interact for purposes of navigating to a specific point of interest entirely within the mobile app and without specific interaction with the digital sign 110. In this manner, consumers do not have to crowd around or congregate around the digital sign 110 for access to navigation to a specific point of interest within the venue. In an embodiment, the mobile app is generic such that it can operated with a variety of different venues having different specific interface components for the interface mechanism 111. In this embodiment, the navigation manager 112 communicates with the generic mobile app to configure the generic mobile app with the interface mechanism 111 for the specific venue and digital sign 110.

In an embodiment, the consumer-operated device 121 is operated by the consumer 120 to scan or tap codes or tags (NFC tags) displayed next to specific points of interest within the venue. Each code or tag for a specific point of interest or a category of selectable points of interest within the venue.

Since the digital sign 110 includes its preconfigured or dynamically and periodically acquired geographical position and, in some cases, includes cartographic data for the venue, the navigation manager 112 can provide navigation data (textually, visually, and/or audibly) for routing the consumer from the consumer's current location (location of the digital sign 110 where the consumer is located) to a specifically selected point of interest (based on the scanned or tapped code from the display of digital sign 110 and through the interface mechanism 111) within the venue. Here, the navigation manager 112 wirelessly communicates the route or navigation data to the mobile app executing on the consumer-operated device 121 and the navigation and routing is provided entirely on the consumer-operated device 121 (such that no memorization is needed by the consumer and such that interactive routing and navigation is provided as the consumer travels with the consumer-operated device 121 within the venue from the location of the digital sign 110 to the selected point of interest within the venue).

In an embodiment, the navigation manager 112 communicates the route/navigation data for the selected point of interest to the mobile app of the consumer-operated device 121 in a format that is recognized by a third-party navigation application (such as Google Maps™ and others). The mobile app then uses an API for the third-party navigation application to initiate that application on the consumer-operated device 121 with the route/navigation data (which may be just specific longitude and latitude positions for the selected point of interest).

In an embodiment, the navigation manager 112 can interact with the mobile app of the consumer operated device 121 to download an entire map (cartographic data) for the entire venue associated with the digital sign 110. The cartographic data can then be processed by the mobile app to provide selection of points of interest within the venue and dynamic route/navigate from the location of the consumer (based on the current location of the consumer-operated device 121) to the selected points of interest within the venue.

In an embodiment, the navigation manager 112 can interact with the mobile app of the consumer operated device 121 to download cartographic data for selected categories of the venue. The cartographic data can then be processed by the mobile app to provide selection of points of interest within the venue for the selected categories and dynamically route/navigate from the location of the consumer (based on the current location of the consumer-operated device 121) to the selected points of interest within the venue for the selected categories.

In fact, the interface mechanism 111 and navigation manager 112 can cooperate with the mobile app of the consumer-operated device to custom download selective cartographic data for the venue. This provides complete control and customization in the hands of the consumer while within the venue.

In an embodiment, the wireless beacon transceiver 113 that provides network connectivity to the consumer-operated device 121 is enabled for wireless communication using one or more of: Low Energy (LE) Bluetooth™, Bluetooth™, NFC, Wifi, cellular, satellite, and Radio Frequency (RF).

One now appreciates how the system 100 provides dynamic and interactive routing/navigation to consumers within any venue utilizing a digital sign 110 and the consumer's own operated device 121. This alleviates all of the issues associated with standalone venue navigation kiosks as discussed above.

FIG. 1B is a diagram of a digital sign 130 employing dynamic interactive navigation, according to an example embodiment. It is noted that the digital sign 130 depicted is one example embodiment of the digital signs described herein, such that the teachings presented herein should not be limited to only the digital sign 130 presented in the FIG. 1B.

In an embodiment, the digital sign 130 is a configured instance of the digital sign 110 of the FIG. 1A.

The digital sign 130 configured for an airport venue and displays a variety of categories for points of interest to the consumer, such as arrivals, departures, check-in, baggage, café, passport control, toilets, shops, flights connecting, telephones, and gates (A1 and A2).

Next to each displayed category is a unique NFC tag 131 that interacts with the consumer-operated device 121 as discussed above to provide routing/navigation and/or cartographic data to the mobile app of the consumer-operated device 121. The consumer-operated device 121 is tapped on a desired NFC tag 121 and navigation and routing then proceeds in any of the manners discussed above with the FIG. 1A and as dictated by the consumer through the consumer-facing mobile app interface executing on the consumer-operated device 121.

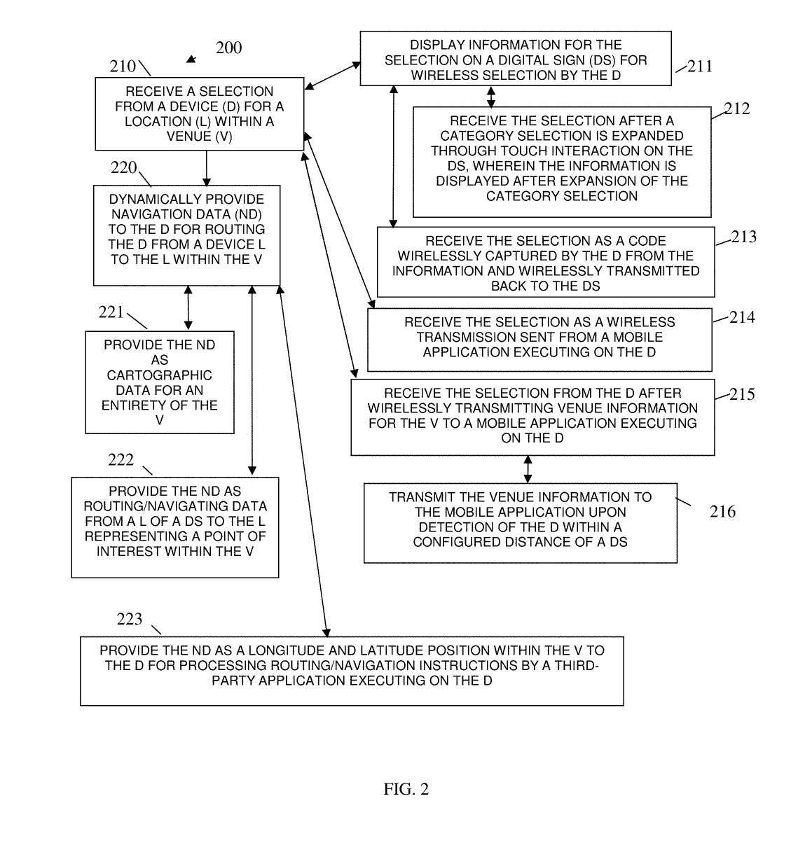

These and other embodiments are now discussed with reference to the FIGS. 2-4.

FIG. 2 is a diagram of a method 200 for dynamic interactive navigation, according to an example embodiment. The software module(s) that implements the method 200 is referred to as a “navigation manager.” The navigation manager is implemented as executable instructions programmed and residing within memory and/or a non-transitory computer-readable (processor-readable) storage medium and executed by one or more processors of a device. The processor(s) of the device that executes the navigation manager are specifically configured and programmed to process the navigation manager. The navigation manager has access to a network during its processing. The network is wireless.

In an embodiment, the device that executes the navigation manager is digital sign 110.

In an embodiment, the device that executes the navigation manager is a server accessible locally at a venue through a wireless Local Area Network (LAN).

In an embodiment, the device that executes the navigation manager is a remote server that is located external and remote from a venue.

In an embodiment, the navigation manager is the navigation manager 112.

In an embodiment, the navigation manager is the interface mechanism 111 and the navigation manager 112.

At 210, the navigation manager receives a selection from a device for a location within a venue. In an embodiment, the device from which the selection is received is the consumer-operated device 121.

In an embodiment, at 211, the navigation manager displays information for the selection on a digital sign for wireless selection by the device.

In an embodiment of 211 and at 212, the navigation manager receives the selection after a category selection is expanded through touch interaction on the digital sign. The information for the selection is displayed after the expansion of the category selection.

In an embodiment of 211 and at 213, the navigation manager receives the selection as a wireless code captured by the device from the information and wirelessly transmitted back to the digital sign. In an embodiment, the code is a QR code displayed adjacent to the information for the selection on the display of the digital sign.

In an embodiment, at 214, the navigation manager receives the selection as a wireless transmission sent from a mobile application executing on the device. This can be a scenario discussed above with the FIG. 1A where the interface mechanism 111 is available through an interface of the mobile application executing on the consumer-operated device 121.

In an embodiment, at 215, the navigation manager receives the selection from device after wireless transmitting venue information for the venue to a mobile application executing on the device.

In an embodiment of 215 and at 216, the navigation manager transmits the venue information to the mobile application upon detection of the device being physically present within a configured distance of a digital sign.

At 220, the navigation manager provides navigation data to the device for routing the device for a physical location of the device to the physical location of the selection within the venue.

In an embodiment, at 221, the navigation manager provides the navigation data as cartographic data for an entirety of the venue.

In an embodiment, at 222, the navigation manager provides the navigation data as routing/navigating data from a physical location of a digital sign to the physical location, which represents a point of interest within the venue.

In an embodiment, at 223, the navigation manager provides the navigation data as a longitude and latitude position within the venue to the device for processing routing/navigating instructions by a third-party application executing on the device.

It is noted that the processing of both the digital sign and the device can be improved with the techniques presented herein by offloading cartographic processing and memory storage of cartographic data between the digital sign and the device.

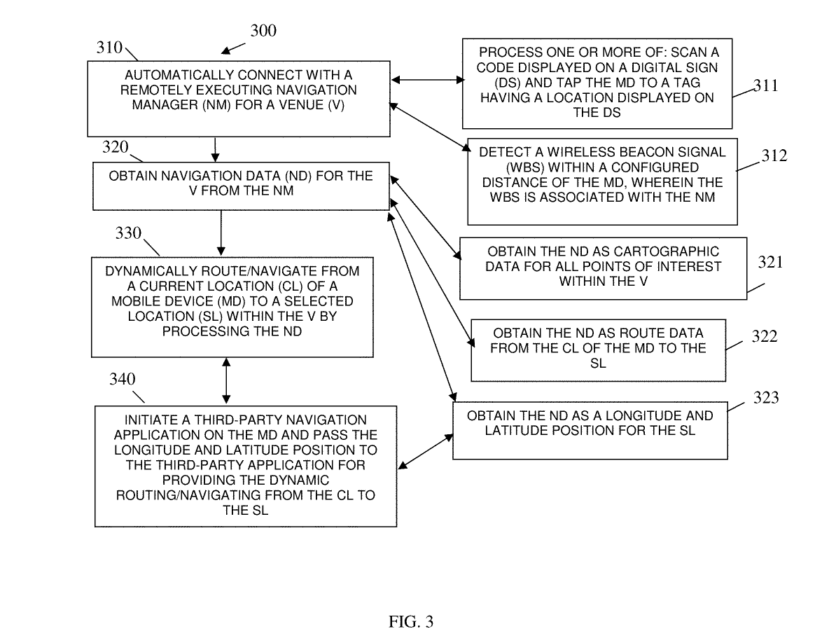

FIG. 3 is a diagram of another method 300 for dynamic interactive navigation, according to an example embodiment. The software module(s) that implements the method 300 is referred to as a “navigation mobile application (app)” The navigation mobile app is implemented as executable instructions programmed and residing within memory and/or a non-transitory computer-readable (processor-readable) storage medium and executed by one or more processors of a hardware device. The hardware processors that execute the navigation mobile app are specifically configured and programmed to process the navigation mobile app. The navigation mobile app has access to at least one wireless network during its processing.

In an embodiment, the navigation mobile app is the mobile app discussed above with the FIG. 1A.

In an embodiment, the device that executes the navigation mobile app is the consumer-operated device 121.

In an embodiment, the device that executes the navigation mobile app is one of: a phone, a tablet, a laptop, and a wearable processing device.

The navigation mobile app interacts with the navigation manager discussed above with the FIG. 2 and/or the navigation manager 112 of the FIG. 1A.

At 310, the navigation mobile app automatically connects with a remotely executing navigation manager, such as the navigation manager 112 and/or the navigation manager discussed above with the discussion of the FIG. 2.

In an embodiment, at 311, the navigation mobile app scans a code displayed on a digital sign and/or the mobile device (executing the navigation mobile app) is tapped to a tag having a location displayed on a digital sign for connecting the navigation mobile app with the navigation manager.

In an embodiment, at 312, the navigation mobile app detects a wireless beacon signal within a configured distance of the mobile device (executing the navigation mobile app) for connecting the navigation mobile app with the navigation manager. The wireless beacon signal is associated with the navigation manager.

At 320, the navigation mobile app obtains navigation data from the venue from the navigation manager.

In an embodiment, at 321, the navigation mobile app obtains the navigation data as cartographic data for all points of interest within the venue. In an embodiment, the navigation mobile app obtains the navigation data as cartographic data for a category of points of interest within the venue.

In an embodiment, at 322, the navigation mobile app obtains the navigation data as route data from the current physical location of the mobile device to the selected physical location within the venue.

In an embodiment, at 323, the navigation mobile app obtains the data as a longitude and latitude position for the physical location of the selection within the venue.

At 330, the navigation mobile app dynamically routes/navigates from a current physical location of the mobile device (executing the navigation mobile app) to the selected location within the venue by processing the navigation data.

In an embodiment of 323 and 330, at 331, the navigation mobile app initiates a third-party navigation application on the mobile device and passes the longitude and latitude position to the third-party navigation application for providing the dynamic routing/navigating from the current location of the mobile device to the selection location within the venue.

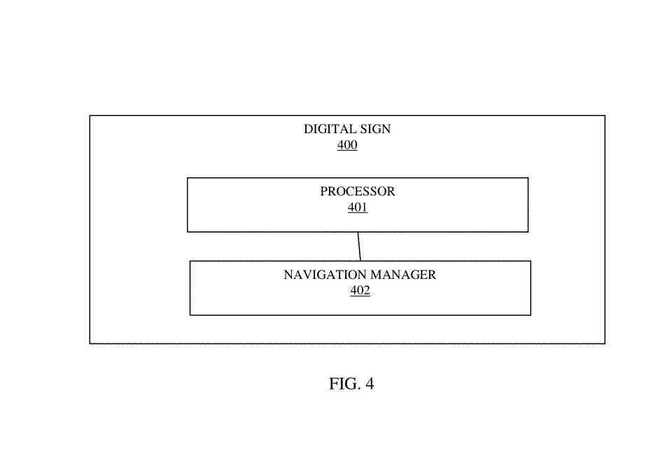

FIG. 4 is a diagram of a digital sign 400, according to an example embodiment. Some components of the digital sign 400 are programmed and reside within memory and/or a non-transitory computer-readable medium and execute on one or more hardware processors of the digital sign 400. The digital sign 400 communicates over at least one wireless network.

In an embodiment, the digital sign 400 is the digital sign 110.

In an embodiment, the digital sign 400 is the digital sign discussed above with reference to the FIGS. 2 and/or 3.

The digital sign 400 includes at least one hardware processor 401 and a navigation manager 402.

The navigation manager 402 is configured to: execute on the processor 401, connect to a mobile device, and wirelessly provide navigation data to the mobile device for dynamically routing/navigating the mobile device to a physical location within a venue

In an embodiment, the mobile device is the consumer-operated device 121.

In an embodiment, the navigation manager 402 is further configured to display a code or a location of a tag on a display of the digital sign 400 for selectively providing the navigation data to the mobile device. In an embodiment, the tag is a NFC-enabled tag.

In an embodiment, the navigation manager 402 is further configured to automatically detect and connect to the mobile device when the mobile device is within a configured distance of the digital sign 400 and cause a mobile application to be initiated and executed on the mobile device for interacting with the digital sign 400.

In an embodiment, the navigation manager 402 is the navigation manager 112.

In an embodiment, the navigation manager 402 is the navigation manager discussed above with reference to the FIG. 2.

It is to be noted that cartographic data can be quite voluminous can be processor intensive to the device processing such data as well as a drain on memory of the device. The various techniques herein permit the memory load and processing load to be alleviated when processing the cartographic data by dynamically distributing and processing the cartographic data between the digital sign and the mobile device. This improves processing throughput and memory utilization of both the digital sign and the mobile device.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving a selection from a device for a location within a venue; and
dynamically providing navigation data to the device for routing the device from a device location to the location within the venue.

2. The method of claim 1, wherein receiving further includes displaying information for the selection on a digital sign for wireless selection by the device.

3. The method of claim 2, wherein displaying further includes receiving the selection after a category selection is expanded through touch interaction on the digital sign, wherein the information is displayed after expansion of the category selection.

4. The method of claim 2, wherein displaying further includes receiving the selection as a code wirelessly captured by the device from the information and wirelessly transmitted back to the digital sign.

5. The method of claim 1, wherein receiving further includes receiving the selection as a wireless transmission sent from a mobile application executing on the device.

6. The method of claim 1, wherein receiving further includes receiving the selection from the device after wirelessly transmitting venue information for the venue to a mobile application executing on the device.

7. The method of claim 6, wherein wirelessly transmitting further includes transmitting the venue information to the mobile application upon detection of the device within a configured distance of a digital sign.

8. The method of claim 1, wherein providing further includes providing the navigation data as cartographic data for an entirety of the venue.

9. The method of claim 1, wherein providing further includes providing the navigation data as routing/navigating data from a location of a digital sign to the location representing a point of interest within the venue.

10. The method of claim 1, wherein providing further includes providing the navigation data as a longitude and latitude position within the venue to the device for processing routing/navigation instructions by a third-party application executing on the device.

11. A method, comprising:
automatically connecting, by a mobile device, with a remotely executing navigation manager for a venue;
obtaining, by the mobile device, navigation data for the venue from the navigation manager; and
dynamically routing/navigating, by the mobile device, from a current location of the mobile device to a selected location within the venue by processing the navigation data.

12. The method of claim 11, wherein automatically connecting further includes one or more of: scanning a code displayed on a digital sign and tapping the mobile device to a tag having a location displayed on the digital sign.

13. The method of claim 11, wherein automatically connecting further includes detecting a wireless beacon signal within a configured distance of the mobile device, wherein the wireless beacon signal is associated with the navigation manager.

14. The method of claim 11, wherein obtaining further includes obtaining the navigation data as cartographic data for all points of interest within the venue.

15. The method of claim 11, wherein obtaining the data further includes obtaining the navigation data as route data from the current location of the mobile device to the selected location.

16. The method of claim 11, wherein obtaining the data further includes obtaining the navigation data as a longitude and latitude position for the selected location.

17. The method of claim 16, wherein dynamically routing/navigating further includes initiating a third-party navigation application on the mobile device and passing the longitude and latitude position to the third-party application for providing the dynamic routing/navigating from the current location to the selected location.

18. A digital sign, comprising:
a processor;
a navigation manager configured to: i) execute on the processor, ii) connect to a mobile device, and iii) provide navigation data to the mobile device for dynamically routing/navigating the mobile device to a location within a venue.

19. The digital sign of claim 18, wherein the navigation manager is further configured to: iv) display a code or a location of a tag on a display of the digital sign for selectively providing the navigation data to the mobile device.

20. The digital sign of claim 18, wherein the navigation manager is further configured, in ii), to: automatically detect and connect to the mobile device when the mobile device is within a configured distance of the digital sign and cause a mobile application to be initiated on the mobile device for interacting with the digital sign.
